(19) United States
(12) Patent Application Publication
(10) Pub. No.: US 2014/0297596 A1
(43) Pub. Date: Oct. 2, 2014

(54) HOME APPLIANCE STORAGE VIRTUALIZATION METHOD AND APPARATUS

(71) Applicant: Intellectual Discovery Co., Ltd., Seoul (KR)

(72) Inventors: Jae Wook JEON, Suwon-si (KR); Seung Hyun YOON, Suwon-si (KR); Seong Jin CHO, Suwon-si (KR); Eun Hye HWANG, Suwon-si (KR); Yeong Jun KIM, Suwon-si (KR)

(73) Assignee: INTELLECTUAL DISCOVERY CO., LTD., Seoul (KR)

(21) Appl. No.: 14/228,886

(22) Filed: Mar. 28, 2014

(30) Foreign Application Priority Data
Mar. 29, 2013 (KR) 10-2013-0034321

(51) Int. Cl. G06F 11/14; G06F 17/30

(52) U.S. Cl. CPC G06F 11/1402; G06F 17/3007; G06F 17/30091; G06F 11/14
USPC 707/675; 707/822; 707/812

(57) ABSTRACT

Provided is a home appliance storage virtualization apparatus including a recognizer to recognize a plurality of home appliances that is disposed in a home network and includes storages, a file system to manage the storages of the plurality of home appliances as a single storage space, and a storage manager to control the plurality of home appliances to access the single storage space using the file system.

### CROSS-REFERENCE TO RELATED APPLICATION

This application claims the priority benefit of Korean Patent Application No. 10-2013-0034321, filed on Mar. 29, 2013, in the Korean Intellectual Property Office, the disclosure of which is incorporated herein by reference.

### BACKGROUND

1. Field of the Invention

The present invention relates to technology for home appliance virtualization.

2. Description of the Related Art

With the propagation of smart home appliances, storages of various home appliances are also being provided. In an existing technology, to share data among home appliances, an additional process of transferring the data by, for example, connecting the home appliances using a cable is required. Also, while a predetermined home appliance is not utilized, storage capacity of another home appliance may be insufficient.

### SUMMARY

According to an aspect of the present invention, there is provided a home appliance storage virtualization apparatus including a recognizer to recognize a plurality of home appliances including storages and being disposed in a home network, a file system to manage the storages of the plurality of home appliances as a single storage space, and a storage manager to control the plurality of home appliances to access the single storage space using the file system.

The home appliance storage virtualization apparatus may further include a backup memory unit to recover lost data when a power supplied to each of the plurality of home appliances is turned off.

The home appliance storage virtualization apparatus may further include a capacity manager to acquire information on an available storage capacity of each of the plurality of home appliances.

The storage manager may distribute data to the storages of the plurality of home appliances based on the information acquired by the capacity manager.

When a predetermined setting exists for a storage to which the data is to be distributed, the storage manager may distribute the data to the storages of the plurality of home appliances by applying the predetermined setting preferentially based on the information acquired by the capacity manager.

The storage manager may assign a grade to respective storages of the plurality of home appliances, and distribute data to the respective storages of the plurality of home appliances based on the grade assigned to the storage.

When a predetermined setting exists for a storage to which the data is to be distributed, the storage manager may distribute the data to the respective storages of the plurality of home appliances by applying the predetermined setting preferentially based on the grade assigned to the storage.

According to another aspect of the present invention, there is also provided a home appliance storage virtualization method including recognizing a plurality of home appliances including storages and being disposed in a home network, managing the storages of the plurality of home appliances as a single storage space, and controlling the plurality of home appliances to access the single storage space using a file system.

The home appliance storage virtualization method may further include recovering lost data when a power supplied to each of the plurality of home appliances is turned off.

The home appliance storage virtualization method may further include acquiring information on an available storage capacity of each of the plurality of home appliances.

The controlling may include distributing data to the storages of the plurality of home appliances based on the information on the available storage capacity of each of the plurality of home appliances.

When a predetermined setting exists for storage to which the data is to be distributed, the controlling may include distributing the data to the storages of the plurality of home appliances by applying the predetermined setting preferentially based on the information on the available storage capacity of each of the plurality of home appliance.

The controlling may include assigning a grade to respective storages of the plurality of home appliances, and distributing data to the respective storages of the plurality of home appliances based on the grade assigned to the storage.

When a predetermined setting exists for a storage to which the data is to be distributed, the controlling may include distributing the data to the respective storages of the plurality of home appliances by applying the predetermined setting preferentially based on the grade assigned to the storage.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an example of a home appliance storage virtualization apparatus according to an example embodiment;

FIG. 2 is a block diagram illustrating a process of managing storages of home appliances using a file system;

FIG. 3 is a block diagram illustrating a data flow in a home appliance storage virtualization apparatus;

FIG. 4 is a block diagram illustrating a process of distributing data based on a capacity of a storage using a storage manager;

FIGS. 5A and 5B are diagrams illustrating a process of distributing data based on grades assigned to storages using a storage manager;

FIG. 6 is a block diagram illustrating another example of a home appliance storage virtualization apparatus according to an example embodiment; and

FIG. 7 is a flowchart illustrating a home appliance storage virtualization method according to an example embodiment.

### DETAILED DESCRIPTION

Hereinafter, embodiments will be described in detail with reference to the accompanying drawings.

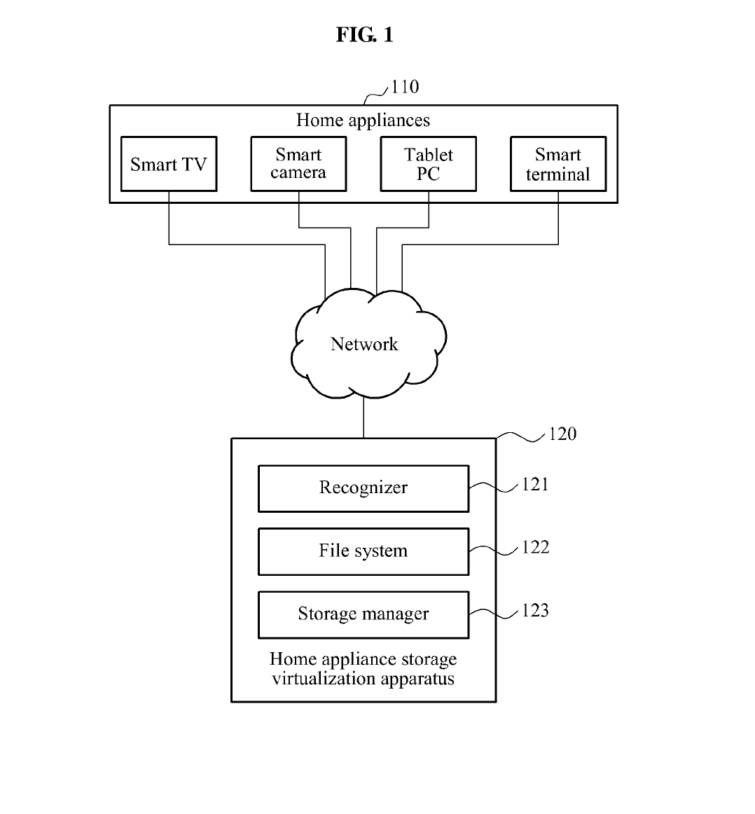

FIG. 1 is a block diagram illustrating an example of a home appliance storage virtualization apparatus 120 according to an example embodiment.

Referring to FIG. 1, the home appliance storage virtualization apparatus 120 according to an embodiment of the present invention may include a recognizer 121, a file system 122, and a storage manager 123.

The recognizer 121 may recognize a plurality of home appliances 110 that is disposed in a home network and includes storages. The home appliance storage virtualization apparatus 120 may allow the plurality of home appliances 110 to share a storage in a home network environment. Thus, each of the plurality of home appliances 110 may need a wireless or wired connection to a network. Also, each the home appliances 110 may need to include the storage. The recognizer 121 may manually or automatically recognize the plurality of home appliances 110 included in the home network based on a setting of a user of the home appliance storage virtualization apparatus 120.

The file system 122 may manage the storages of the plurality of home appliances 110 recognized by the recognizer 121 as a single storage space. When the home appliances 100 write or read data, a unique address may be assigned to each of the storages such that the data may be written or read based on the unique address. Using the file system 122, each of the home appliances 110 may recognize storage spaces physically separated, into the single logical storage space.

The storage manager 123 may control the plurality of home appliances 110 to access the single logical storage space using the file system 122. When the plurality of home appliances 110 is to read or write data, the storage manager 123 may disallow direct access by the home appliances 110 to the storages of the home appliances 110, and control the home appliances 110 to access the storages using the file system 122. The storage manager 123 may provide an integrated platform to various home appliances.

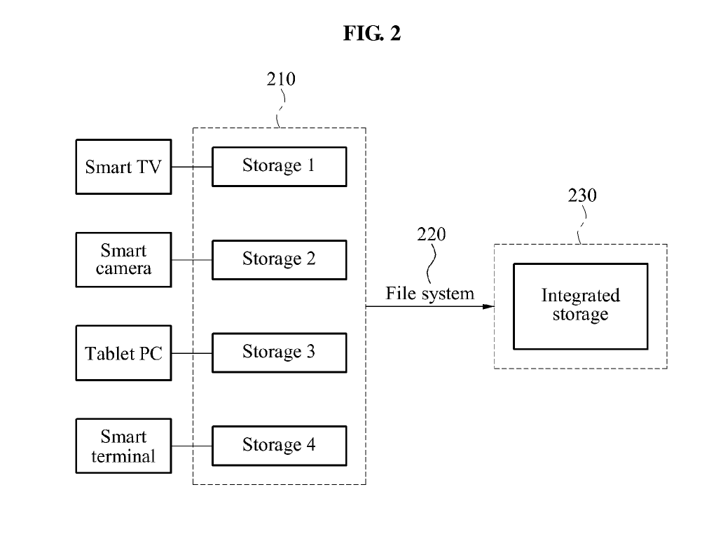

FIG. 2 is a block diagram illustrating a process of managing storages 210 of home appliances using a file system 220.

Referring to FIG. 2, the file system 220 may manage the storages 210 of a plurality of home appliances as a single integrated storage 230. The integrated storage 230 may be a storage space logically reconfigured through virtualization of the storages 210 of the plurality of home appliances. Each of the home appliances may write or read data on the integrated storage 230 using the file system 220. When performing direct access by each of the home appliances without using the file system 220 is determined to be relatively efficient, each of the home appliances may be allowed to access a corresponding storage based on a predetermined setting.

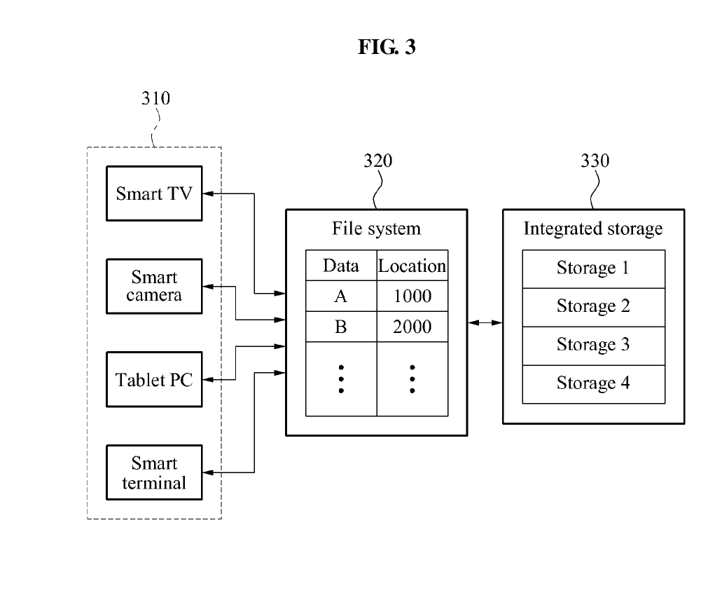

FIG. 3 is a block diagram illustrating a data flow in a home appliance storage virtualization apparatus.

Referring to FIG. 3, a plurality of home appliances 310 may access an integrated storage 330 via a file system 320. Data may be written or read based on a correspondence relationship between the data stored in the file system 320 and a corresponding location. Each of the home appliances 310 may share a storage using the integrated storage 330. The integrated storage 330 may have an advantage in view of a storage capacity of each of the home appliances. Also, costs may be reduced through efficient use of a storage space. Since such a storage management scheme may lead users to purchase products from identical manufacturers, the user may be involved in a system of a particular company.

By allowing each of the home appliances 310 to share a storage, video captured using a smart TV may be represented in a tablet PC, and an image photographed using a smart camera may be shown in a smart TV. Through this, a degree of an effort necessary to transfer data to each of the home appliances 310 may be reduced.

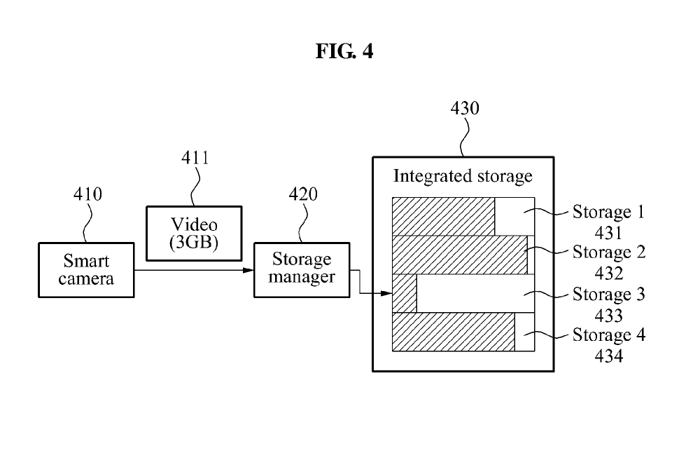

FIG. 4 is a block diagram illustrating a process of distributing data based on a capacity of a storage using a storage manager 420.

Referring to FIG. 4, the storage manager 420 may distribute data based on a capacity of each storage space. A capacity manager (not shown) may periodically acquire information on a capacity of corresponding storage. The information on the capacity of the corresponding storage may include information on a maximum capacity of the storage, an available capacity, or a capacity of a separate storage obtained by a user.

The storage manager 420 may designate a space for storing data on each home appliance based on the information acquired by the capacity manager. For example, when a space for storing a video 411 captured by a smart camera 410 needs to be obtained, the video 411 may be stored in a storage 3 433 having a largest capacity among a storage 1 431, a storage 2 432, the storage 3 433, and a storage 434 of an integrated storage 430.

When a predetermined home appliance is set to use a predetermined storage, data may be stored in the predetermined storage without the aforementioned process.

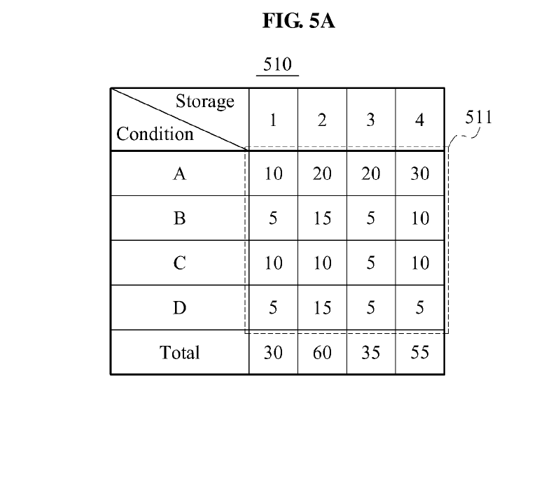

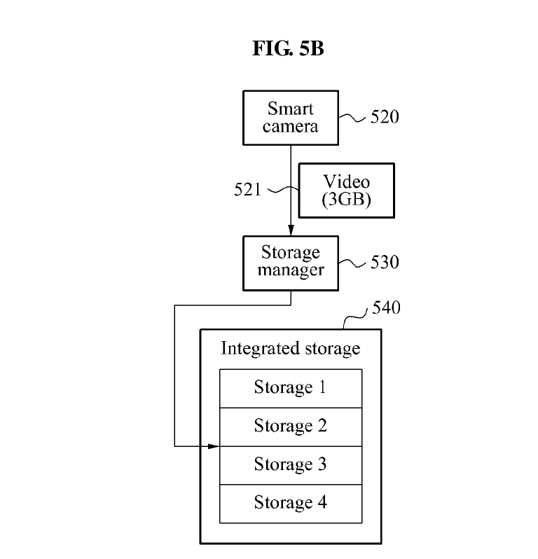

FIGS. 5A and 5B are diagrams illustrating a process of distributing data based on grades 511 assigned to storages using a storage manager 530.

Referring to FIGS. 5A and 5B, the storage manager 530 may assign the grades 511 to the storages, and designate a storage space for storing data on a predetermined home appliance based on a grade assigned to a corresponding storage. A condition for assigning the grades 511 to the storages may be, for example, a time at which data is last stored, a network status, an available capacity, and a proportion of a remaining amount to an entire capacity. The data may be stored in a storage acquiring the highest grade through aggregation of the grades 511 assigned based on the condition.

For example, a space for storing a video 521 captured by a smart camera 520 may be designated based on the grades 511 assigned to each of the storages. The grades 511 may be managed using a table 510 of FIG. 5A. In the table 510, since a storage 2 acquires the to highest grade, the storage manager 530 may store the video 521 in a space of the storage 2 of an integrated storage 540.

When a predetermined home appliance is set to use a predetermined storage, data may be stored in the predetermined storage without the aforementioned process.

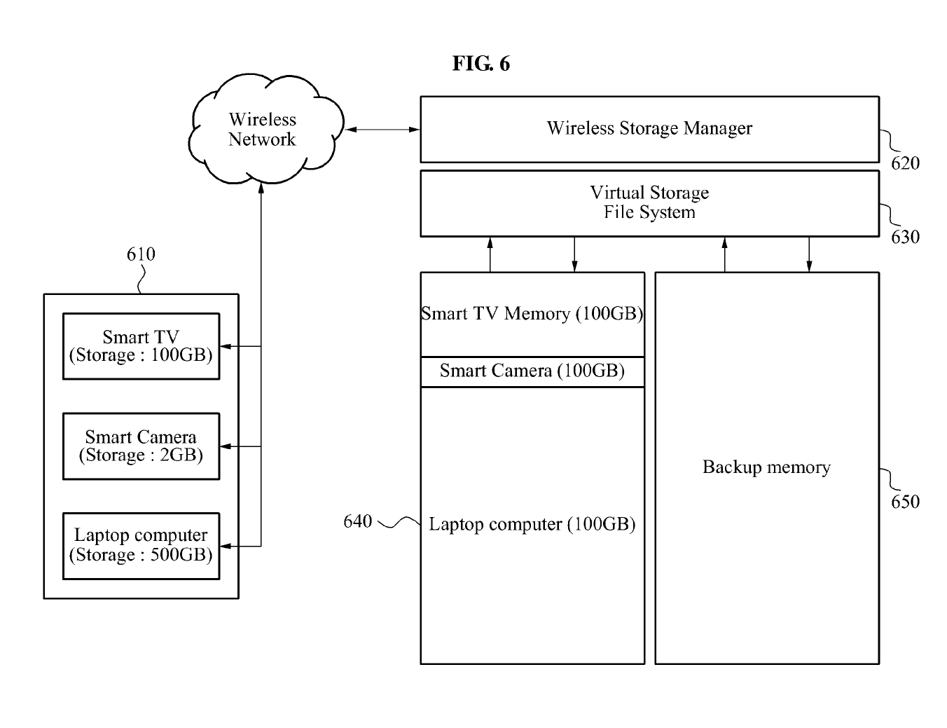

FIG. 6 is a block diagram illustrating another example of a home appliance storage virtualization apparatus according to an example embodiment.

Referring to FIG. 6, the home appliance storage virtualization apparatus may include a wireless storage manager 620 and a virtual storage file system 630.

The wireless storage manager 620 and the virtual storage file system 630 may manage an integrated storage 640 and a backup memory 650. The integrated storage 640 may be a storage reconfigured to be a single storage space using storages 610 of the home appliances. The backup memory 650 may backup a file system in preparation for a power-off of a home appliance under unexpected conditions. To prepare for an occurrence of the power-off of the home appliance, a journaling system may be required in preparation for a loss of the file system. The backup memory 650 may be used for the journaling system.

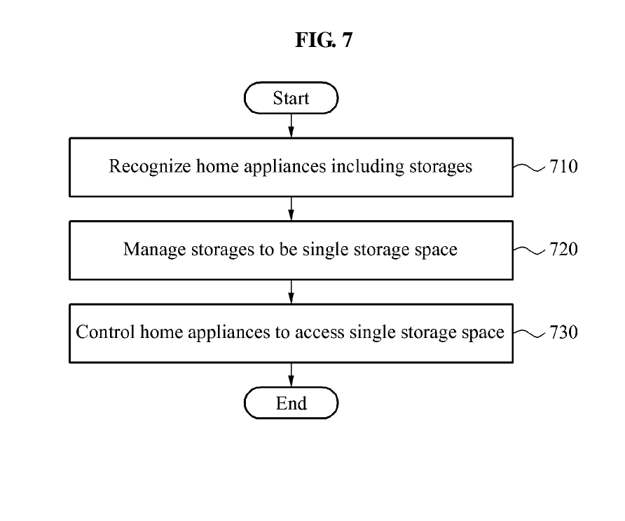

FIG. 7 is a flowchart illustrating a home appliance storage virtualization method according to an example embodiment.

Referring to FIG. 7, in operation 710, a plurality of home appliances that is disposed in a home network and includes storages may be recognized.

In the home appliance storage virtualization method, the plurality of home appliances may be allowed to share a storage in a home network environment. Thus, each of the plurality of home appliances may need a wired or wireless connection to a network. Each of the home appliances may need to include the storage. In an operation of the recognizing of the plurality of home appliances, the plurality of home appliances included in the home network may be manually or automatically recognized based on a setting of a user of the home appliance storage virtualization method.

In operation 720, the storages of the plurality of home appliances may be managed as a single storage space using a file system.

In an operation of the managing of the storages of the plurality of home appliances as the single storage space using the file system, the storages of the plurality of home appliances recognized by the recognizer may be managed as the single storage space. When the home appliances write or read data, a unique address may be assigned to each of the storages such that the data may be written or read based on the unique address. Using the file system, each of the home appliances may recognize storage spaces physically separated, as the single logical storage space.

In operation 730, the plurality of home appliances may be controlled to access the single storage space using the file system.

In an operation of the controlling of the plurality of home appliances to access the single storage space using the file system, the plurality of home appliances may be controlled to access the logical storage space using the file system. When the plurality of home appliances is to read or write data, the storage manager may disallow directly access by the home appliances to the storages of the home appliances, and control the home appliances to access the storages using the file system. In the operation of controlling of the plurality of home appliances to access the single storage space using the file system, an integrated platform may be provided to various home appliances.

In the operation of the controlling of the plurality of home appliances to access the single storage space using the file system, an access to a predetermined storage space may be controlled to be performed based on information on each of the storages, information assigned to the storages based on a predetermined reference, or a predetermined setting. In this operation, a predetermined home appliance may be controlled to access a predetermined storage space based on, for example, a capacity of each of the storages, a network status, and the like.

In the home appliance storage virtualization method, an operation of recovering lost data may be included. The operation of recovering the lost data may be performed using a backup memory. The backup memory may backup a file system in preparation for a power-off of a home appliance under unpredictable circumstances. To prepare for an occurrence of the power-off of the home appliance, a journaling system may be required in preparation for a loss of the file system. The backup memory may be used for the journaling system.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A home appliance storage virtualization apparatus comprising:
a recognizer to recognize a plurality of home appliances including storages and being disposed in a home network;
a file system to manage the storages of the plurality of home appliances as a single storage space; and
a storage manager to control the plurality of home appliances to access the single storage space using the file system.

2. The apparatus of claim 1, further comprising:
a backup memory unit to recover lost data when a power supplied to each of the plurality of home appliances is turned off.

3. The apparatus of claim 1, further comprising:
a capacity manager to acquire information on an available storage capacity of each of the plurality of home appliances.

4. The apparatus of claim 3, wherein the storage manager distributes data to the storages of the plurality of home appliances based on the information acquired by the capacity manager.

5. The apparatus of claim 4, wherein when a predetermined setting exists for a storage to which the data is to be distributed, the storage manager distributes the data to the storages of the plurality of home appliances by applying the predetermined setting preferentially based on the information acquired by the capacity manager.

6. The apparatus of claim 1, wherein the storage manager assigns a grade to respective storages of the plurality of home appliances, and distributes data to the respective storages of the plurality of home appliances based on the grade assigned to the storage.

7. The apparatus of claim 6, wherein when a predetermined setting exists for a storage to which the data is to be distributed, the storage manager distributes the data to the respective storages of the plurality of home appliances by applying the predetermined setting preferentially based on the grade assigned to the storage.

8. A home appliance storage virtualization method comprising:
recognizing a plurality of home appliances including storages and being disposed in a home network;
managing the storages of the plurality of home appliances as a single storage space; and
controlling the plurality of home appliances to access the single storage space using a file system.

9. The method of claim 8, further comprising:
recovering lost data when a power supplied to each of the plurality of home appliances is turned off.

10. The method of claim 8, further comprising:
acquiring information on an available storage capacity of each of the plurality of home appliances.

11. The method of claim 10, wherein the controlling comprises distributing data to the storages of the plurality of home appliances based on the information on the available storage capacity of each of the plurality of home appliances.

12. The method of claim 11, wherein when a predetermined setting exists for a storage to which the data is to be distributed, the controlling comprises distributing the data to the storages of the plurality of home appliances by applying the predetermined setting preferentially based on the information on the available storage capacity of each of the plurality of home appliances.

13. The method of claim 8, wherein the controlling comprises assigning a grade to respective storages of the plurality of home appliances, and distributing data to the respective storages of the plurality of home appliances based on the grade assigned to the storage.

14. The method of claim 13, wherein when a predetermined setting exists for a storage to which the data is to be distributed, the controlling comprises distributing the data to the respective storages of the plurality of home appliances by applying the predetermined setting preferentially based on the grade assigned to the storage.
